(19) United States
(12) Patent Application Publication
(10) Pub. No.: US 2015/0193519 A1
(43) Pub. Date: Jul. 9, 2015

(54) MODELING AND VISUALIZING LEVEL-BASED HIERARCHIES

(71) Applicant: International Business Machines Corporation, Armonk, NY (US)

(72) Inventors: Dan J. Mandelstein, Austin, TX (US); Sushain Pandit, Austin, TX (US); Subramanian Palaniappan, Bangalore (IN); Olena Woolf, Toronto (CA); Fenglian Xu, Eastleigh (GB)

(73) Assignee: International Business Machines Corporation, Armonk, NY (US)

(21) Appl. No.: 14/150,808

(22) Filed: Jan. 9, 2014

(51) Int. Cl. G06F 17/30

(52) U.S. Cl. CPC G06F 17/30595

(57) ABSTRACT

Flexibly modeling and visualizing a level-based hierarchy. A first level set and a second level set are identified from a first data set and a second data set in a first domain and a second domain, respectively. A first relationship type to be used between the first level set and the second level set is received. A first hierarchy is formalized, including at least the first level set and the second level set joined in a hierarchical relationship according to the first relationship type.

### FIELD OF THE INVENTION

The present invention relates generally to the field of data warehousing, and more particularly to modeling and visualizing level-based hierarchies.

### BACKGROUND OF THE INVENTION

Level-based hierarchies are a well-known concept, commonly used in data warehouses (logical dimensions) to perform analytical operations like roll-ups and/or drill-downs for reporting purposes. For example, a hierarchy on the Geography dimension might include Continents, Countries, States and Cities as levels of the hierarchy. Each level is constructed from a domain of values coming from the respective set (of Continents, Countries, States or Cities). A time dimension having a hierarchy that represents data at month, quarter, and year levels is another example of a level-based hierarchy. Depending on the kind of hierarchy and the source(s) where the data and relationships are being pulled from, the edges can have some associated semantics.

There are two types of logical dimensions: dimensions with level-based hierarchies (structure hierarchies), and dimensions with parent-child hierarchies (value hierarchies). Level-based hierarchies are those in which members are of several types, and members of the same type occur only at a single level, while in parent-child hierarchies, members all have the same type. Unlike level-based hierarchies, value hierarchies may not have well-defined, generalizable levels. A hybrid hierarchy, as the name suggests, has some members related via level-based relationships, while others are related via value-based relationships.

### SUMMARY

According to one aspect of the present invention, there is a computer program product, system and/or method which performs the following actions (not necessarily in the following order and not necessarily in serial sequence): (i) identifying a first set of machine readable data including a first level set from a first domain; (ii) identifying a second set of machine readable data including a second level set from a second domain; (iii) receiving a first relationship type to be used between the first level set and the second level set; and (iv) formalizing a first hierarchy, including at least the first level set and the second level set joined in a hierarchical relationship according to the first relationship type.

### BRIEF DESCRIPTION OF THE SEVERAL VIEWS OF THE DRAWINGS

FIG. 1 is a schematic view of a first embodiment of a computer system (that is, a system including one or more processing devices) according to the present invention;

FIG. 2 is a flowchart showing a process performed, at least in part, by the first embodiment computer system;

FIG. 3 is a schematic view of a portion of the first embodiment computer system;

FIG. 4 is a diagram of a hierarchy from a second embodiment computer system;

FIG. 5 is a diagram of a hierarchy from a third embodiment computer system;

FIG. 6 is a diagram of a hierarchy from a fourth embodiment computer system;

FIG. 7 is a diagram of a hierarchy modeling framework from a fifth embodiment computer system;

FIG. 8 is a first screenshot from a fifth embodiment computer system;

FIG. 9 is a second screenshot from a fifth embodiment computer system; and

FIG. 10 is a diagram of a fifth embodiment computer system.

### DETAILED DESCRIPTION

This Detailed Description section is divided into the following sub-sections: (i) The Hardware and Software Environment; (ii) Example Embodiment; (iii) Further Comments and/or Embodiments; and (iv) Definitions.

### I. THE HARDWARE AND SOFTWARE ENVIRONMENT

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java (note: the term(s) “Java” may be subject to trademark rights in various jurisdictions throughout the world and are used here only in reference to the products or services properly denominated by the marks to the extent that such trademark rights may exist), Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

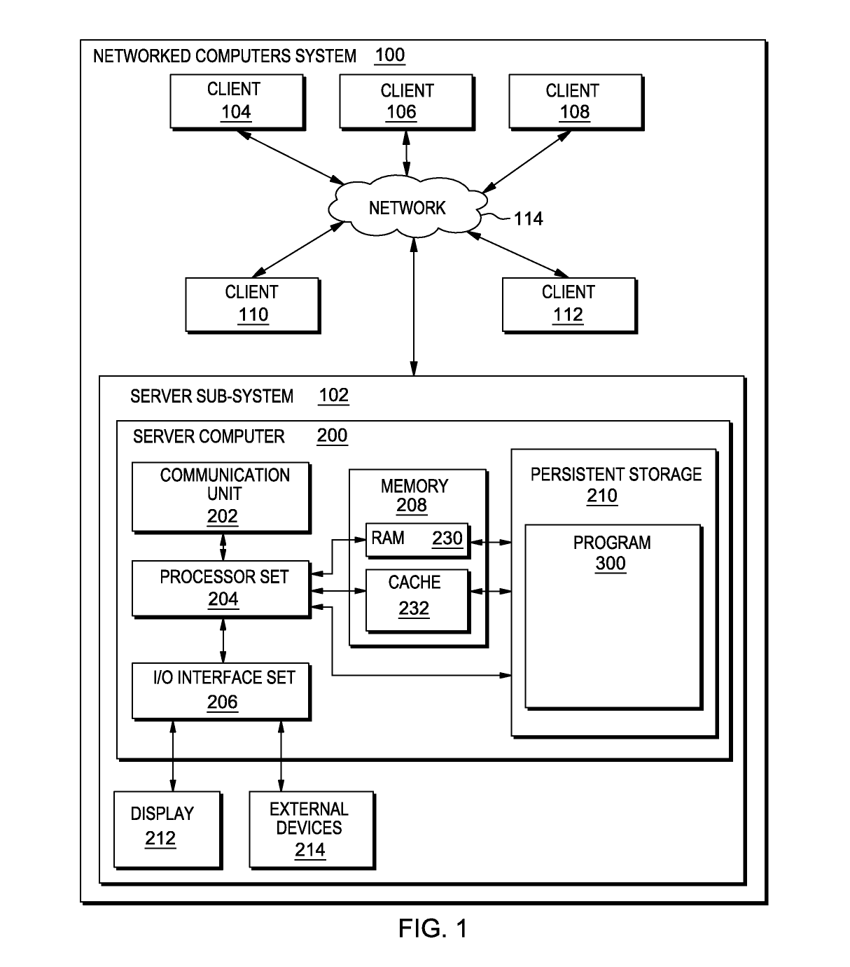

An embodiment of a possible hardware and software environment for software and/or methods according to the present invention will now be described in detail with reference to the Figures. FIG. 1 makes up a functional block diagram illustrating various portions of networked computers system 100, including: server computer sub-system (that is, a portion of the larger computer system that itself includes a computer) 102; client computer sub-systems 104, 106, 108, 110, 112; communication network 114; server computer 200; communication unit 202; processor set 204; input/output (i/o) interface set 206; memory device 208; persistent storage device 210; display device 212; external device set 214; random access memory (RAM) devices 230; cache memory device 232; and program 300.

As shown in FIG. 1, server computer sub-system 102 is, in many respects, representative of the various computer sub-system(s) in the present invention. Accordingly, several portions of computer sub-system 102 will now be discussed in the following paragraphs.

Server computer sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage and control certain software functions that will be discussed in detail, below, in the Example Embodiment sub-section of this Detailed Description section.

Server computer sub-system 102 is capable of communicating with other computer sub-systems via network 114 (see FIG. 1). Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

It should be appreciated that FIG. 1 provides only an illustration of one implementation (that is, system 100) and does not imply any limitations with regard to the environments in which different embodiments may be implemented. Many modifications to the depicted environment may be made, especially with respect to current and anticipated future advances in cloud computing, distributed computing, smaller computing devices, network communications and the like.

As shown in FIG. 1, server computer sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102, such as client sub-systems 104, 106, 108, 110, 112. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

### II. EXAMPLE EMBODIMENT

Preliminary note: The flowchart and block diagrams in the following Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

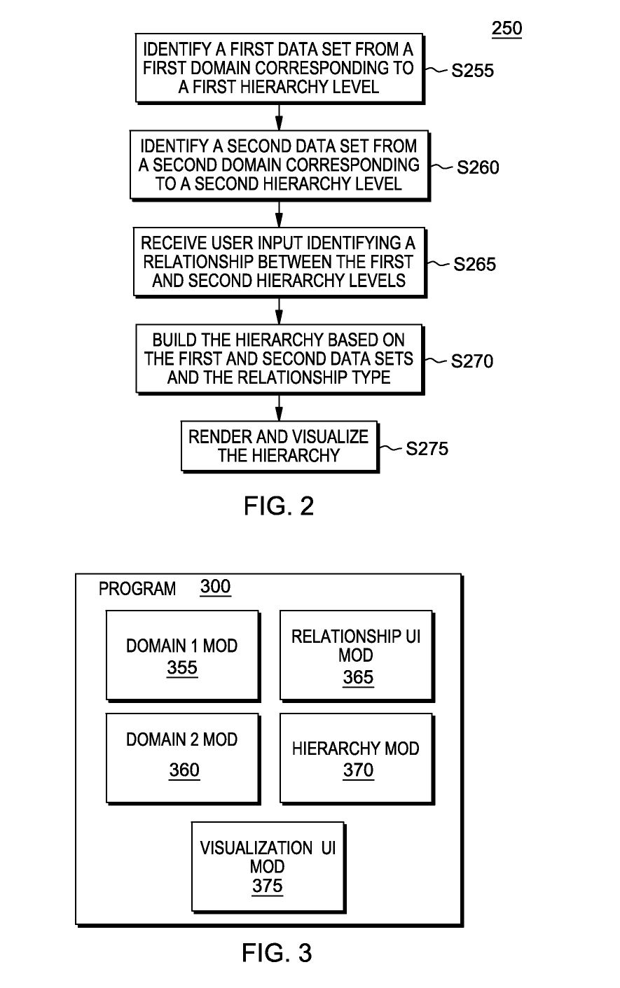

FIG. 2 shows flowchart 250 depicting a method according to the present invention. FIG. 3 shows program 300 for performing at least some of the method steps of flowchart 250. This method and associated software will now be discussed, over the course of the following paragraphs, with extensive reference to FIG. 2 (for the method step blocks) and FIG. 3 (for the software blocks).

Processing begins at step S255, where relationship user interface (UI) mod 365 is used to identify a first set of data, or level set, to become the first (top) level of a level-based hierarchy. Here, the data set “Employers” (not shown), which resides in domain 1 mod 355, is identified as the first data set. Domain 1 mod 355 is part of program 300 on server computer 200 (see FIG. 1). Alternatively, domain 1 mod 355 could be part of a different program (not shown) on server computer 200, and/or could be located on client 104. Indeed, domain 1 mod 355 could reside on any type of system anywhere, as long as relationship UI mod 365 of program 300 on server computer 200 has some way of referencing the “Employers” data set.

Relationship UI mod 365 is also used to optionally identify the relationship of the first level set with itself. The first level set “Employers” in this embodiment is a simple set. In a simple set, there is no particular relationship specified among the members of the set. Therefore, no relationship is identified here. Alternatively, the first level set could be a simple hierarchy (also know as a parent-child hierarchy, set hierarchy, or tree hierarchy), where some or all of the data objects in the set are related to one another in a hierarchical fashion. For example, a simple hierarchy could indicate subsidiary relationships among the various members of the “Employers” data set. In such a case, that hierarchy would also be identified in this step Like the data set itself, the hierarchy information could reside on any type of system anywhere, as long as relationship UI mod 365 of program 300 on server computer 200 has some way of referencing it.

Processing proceeds to step S260, where relationship UI mod 365 is used to identify a second set of data, or level set, to become the second level of a level-based hierarchy. This step is analogous to step S255, but for the second level set. In this embodiment, the second level set is “Employees” (not shown), which resides in domain 2 mod 360. In some embodiments, a level suggestion module is employed to make intelligent suggestions for the second level (and beyond) based on information found in enterprise dictionaries, glossaries, ontologies, and the like.

Processing proceeds to step S265, where relationship UI mod 365 is used to identify a relationship between the first and second hierarchy levels that were identified in the previous two steps. Here, second level set “Employees” is related to first level set “Employers” via hasEmployer, a property, or attribute, of each member of the “Employees” data set that specifies that member's employer in the “Employers” data set. Alternatively, the relationship could be a map relationship, whereby the relationship between members of “Employers” and members of “Employees” is mapped out in a dedicated table. Alternatively, the relationship could be a rule-based relationship, such as “If Employee.State is California, then Employer is CalCo, else Employer is GenCo.” As with the data sets and simple hierarchy information (if present), the relationship information could reside on any type of system anywhere, as long as relationship UI mod 365 of program 300 on server computer 200 has some way of referencing it. Some alternative embodiments include an application programming interface (API) mod instead of or in addition to a relationship UI mod, such that the identification and manipulation of the hierarchy levels and relationships can be done programmatically.

Processing proceeds to step S270, where hierarchy mod 370 builds the level-based hierarchy using the first and second data sets and the relationship between them, identified through relationship UI mod 365 as specified above. The hierarchy that mod 370 builds is at the data-set level, meaning that only set-level information is maintained in the hierarchy model. For instance, the hierarchy created here by hierarchy mod 370 has a hierarchy id (“H_1”), a hierarchy name (“Employee_Hierarchy”), a reference to first level data set “Employers” and the level number of that set (“Level 1”), a reference to second level data set “Employees” and the level number of that set (“Level 2”), a relationship type (“Property”) connecting these two levels, and a reference to the relationship information (how to access the hasEmployer property of the “Employees” data set).

Such a model permits a great deal of flexibility in defining level-based hierarchies, as the data sets at each level may come from different domains and/or systems, the relationship type may be different at each level of the hierarchy, and/or each relationship may have a different cardinality (e.g. one-to-one, one-to-many, many-to-one, many-to-many). It can, for instance, accommodate both a homogeneous hierarchy, where each edge (that is, a connector that represents the relationship between two nodes of the hierarchy) has an implicit or fixed meaning or semantics (for example, an “is-a” or “has-a” relationship, where each subsequent level has this same relationship to the level above it, such as Country-hasA-State-hasA-City), as well as hierarchies where relationships along different edges in the hierarchy have different meanings/semantics depending on the level (such as Country-hasA-State-hasPopulation-Population).

Processing proceeds to step S275, where visualization user interface (UI) mod 375 renders the hierarchy and displays it to the user. Visualization UI mod 375 does this using the data in the hierarchy built by hierarchy mod 370, together with access to the data and relationships that hierarchy references. In some embodiments, this step is optional.

### III. FURTHER COMMENTS AND/OR EMBODIMENTS

Some embodiments of the present disclosure recognize that one of the challenges in defining level-based hierarchies is to consolidate all the level data and the associated relationships connecting that data so that a hierarchy can be formed. Often, the data is imported from data marts or other information sources and connections are then manually made, but these connections do not always correspond to how the level data and their associated relationships were represented in their original sources. This presents a synchronization problem. In addition, since different kinds of relationships, or cardinalities, can exist between data (for instance, one-to-one, one-to-many, or many-to-many), unless there is a streamlined level hierarchy model that can accommodate all those relationships, it is not easy or sometimes even feasible to pull them into a level hierarchy definition.

Some embodiments of the present disclosure recognize that, similarly, different kinds of data objects can exist in different systems. For example, a person-organization chart may have a level hierarchy where the first three levels are Country, State and City (coming from a reference data management system), while the fourth level is Person (coming from a master data management system). A streamlined level hierarchy model should be able to accommodate this domain specificity in data.

Some embodiments of the present disclosure recognize that another challenge is to make intelligent suggestions to the user defining the multi-level hierarchy, especially in cases where data and/or relationships may be coming from multiple sources. For example, suggesting “Cities” as the third level, once a user has defined “States” and “Countries” at the second level and the first level, respectively.

Some embodiments of the present disclosure recognize that, due to these issues: (i) it is desirable to have an easy way to utilize existing relationships and the data they connect, whenever possible, through an extensible interface that allows plugging in data from different domains (often residing in different systems) while defining the level hierarchy; (ii) the design should be flexible enough to accommodate various kinds of data and relationships; and/or (iii) there should be some form of intelligence to make suggestions based on the active context of the hierarchy definition.

Some embodiments of the present disclosure form a flexible framework that allows a user to easily model and visualize level-based hierarchies over different kinds of data (potentially pulled in from different systems and representing different domains) and data relationships (one-to-many, many-to-many, parent-child, and so forth). This flexible framework is based on an extensible model that addresses the issues raised above. The design flexibility permits level hierarchies to be defined over data and relationships from different systems and domains. Reference data is a special class of metadata/master data, which is used to categorize other data present in an enterprise and which gets referenced across multiple systems. A reference data set is a collection of reference data values.

Some embodiments of the present disclosure provide the following features, characteristics, and/or benefits: (i) define a streamlined level hierarchy model that is able to accommodate different ‘kinds’ of data objects that exist in different systems; (ii) define a streamlined model that is able to accommodate different ‘kinds’ of relationships existing between data (one-to-one, one-to-many, many-to-many); (iii) make intelligent suggestions to a user based on the active level-hierarchy definition context; (iv) eliminate the need to consolidate data and associated relationships connecting that data and instead define references to the actual data and pull those references and their relationships into a central managed hierarchy definition; and/or (v) eliminate the synchronization problem.

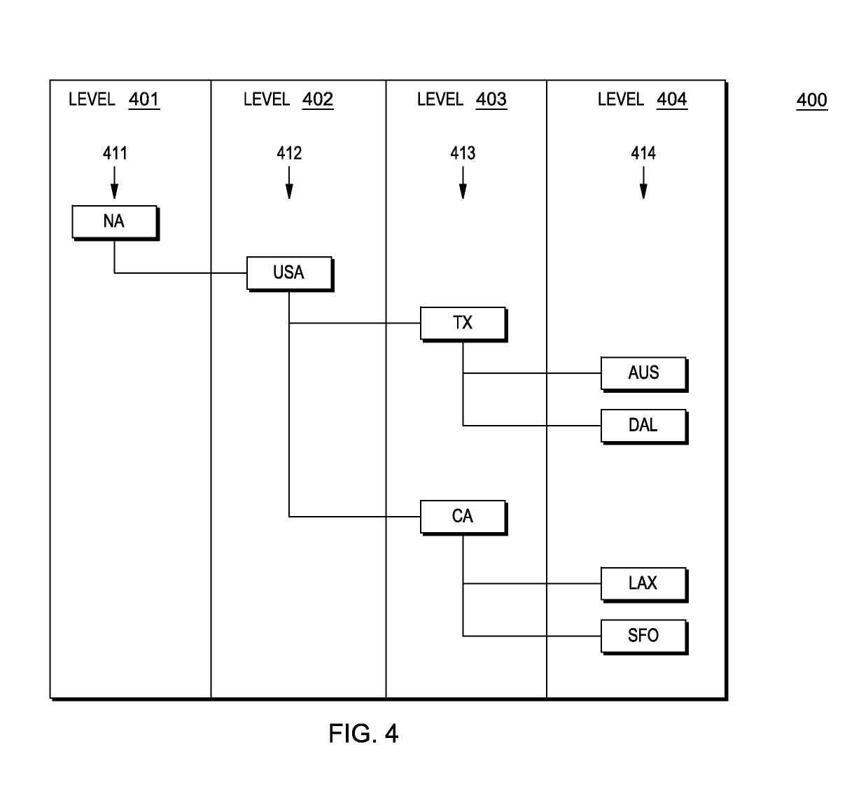

FIGS. 4-6 present illustrative examples of the kinds of scenarios addressed by various embodiments of the present disclosure. Shown in FIG. 4 is level-based hierarchy 400, containing the following levels: highest level 401; intermediate level 402; intermediate level 403; and lowest level 404. Levels 401, 402, 403, and 404 contain data sets Continents 411, Countries 412, States 413, and Cities 414, respectively. This simple level-based hierarchy was constructed using these four data sets, which are represented here as reference data (code tables). Relationships between these sets are modeled as an attribute going from a lower-level set to higher-level set. For example, City hasState State, while State hasCountry Country. Alternatively, the relationships between sets can be represented as a mapping going from a lower-level set to a higher-level set: City→State, State→Country. Continents, Countries, States, and Cities are all persistent in a single reference data management hub. Alternatively, they could each come from different sources, and different relationships could be used to connect them.

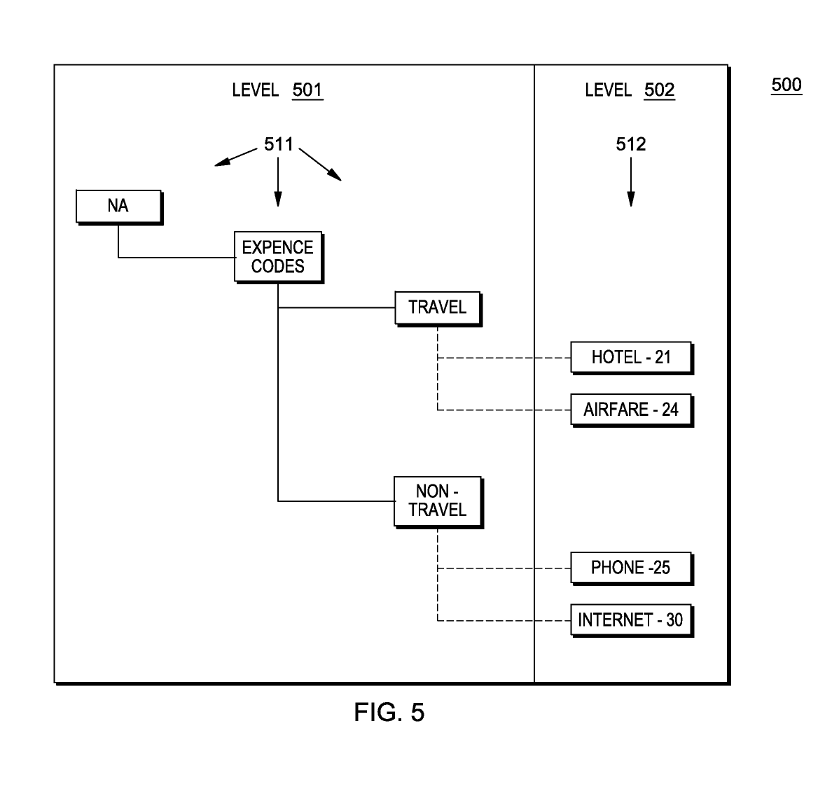

FIG. 5 shows another hierarchy, 500, with top level 501 and bottom level 502, containing Expense Classes 511 and Codes 512, respectively. In hierarchy 500, level 501 comprises a simple hierarchy over values from the set of expense classes 511, while level 502 comprises of a simple level, taking values from the set of codes 512. Relationships at level 501 come from a simple tree (parent-child hierarchy), while those connecting level 502 (leaf nodes) to level 501 nodes are mapping relations. Alternatively, these latter connections could be attribute relations. Hierarchy 500 is an example of a hybrid hierarchy.

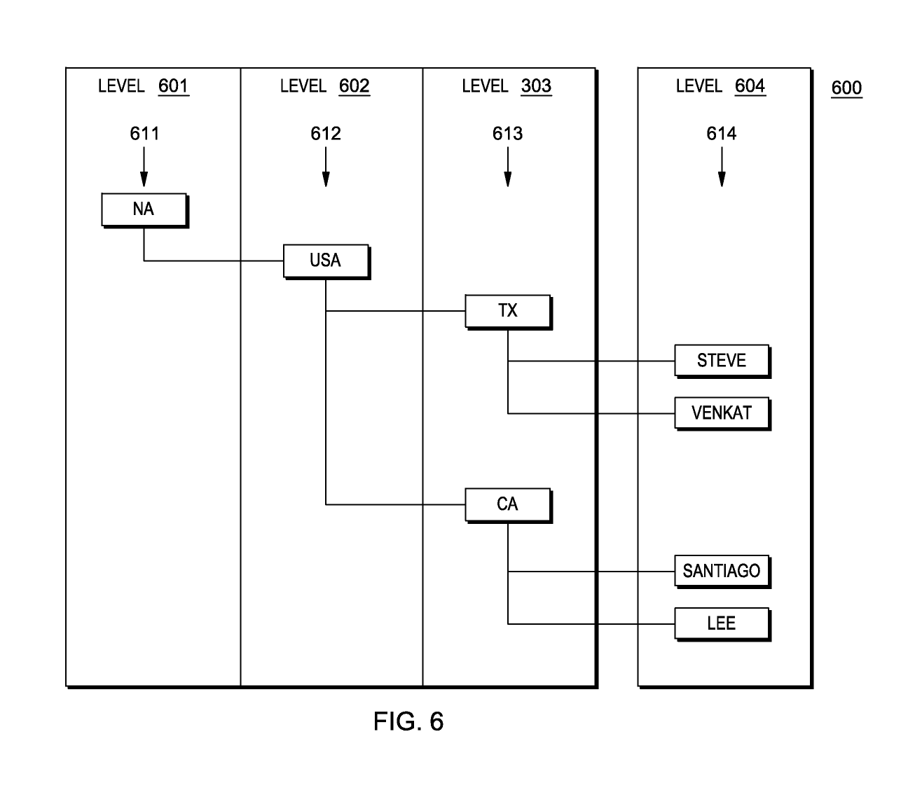

FIG. 6 shows hierarchy 600, where the first three levels—601, 602, and 603—come from one system, while level 604 is coming from another system. These levels contain data sets Continents 611, Countries 612, Cities 613, and Names 614, respectively.

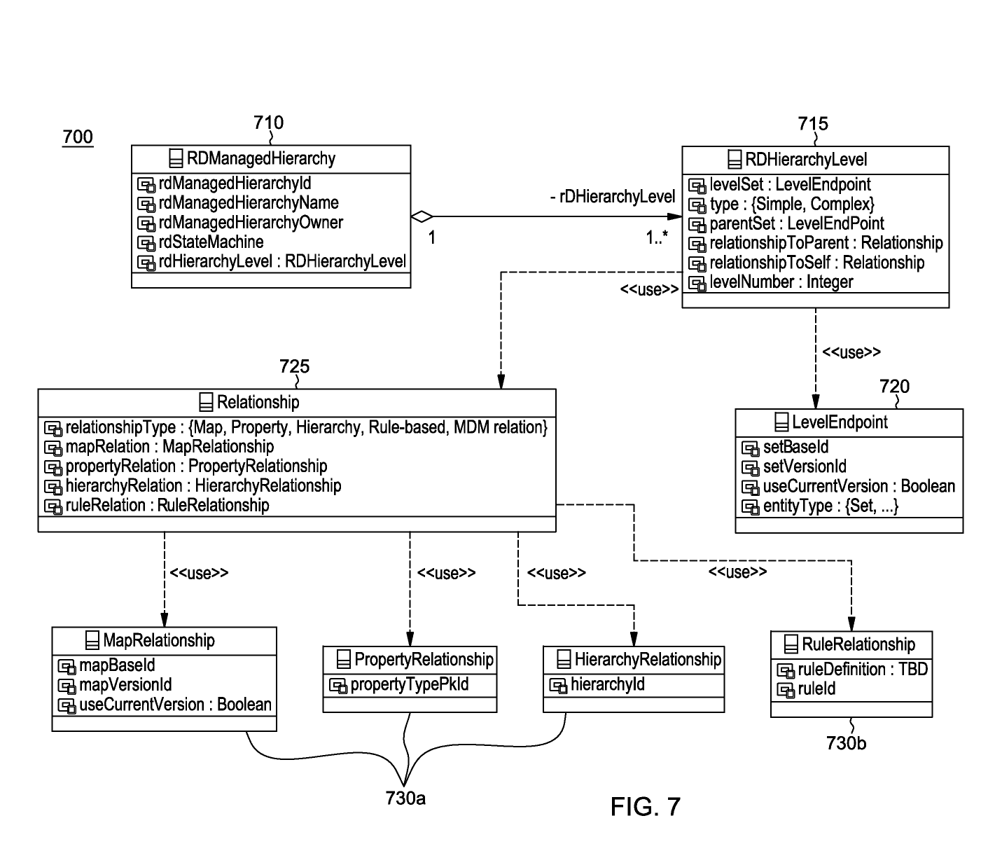

An exemplary embodiment of the present disclosure will now be discussed, with reference to FIGS. 7, 8, 9, and 10. Most concepts, although specific in nature for purposes of elaboration, are generic in nature and can be extrapolated to various similar scenarios. The embodiment constitutes a relationship model and associated framework that is flexible enough to accommodate different kinds of relationships and end points. It is also flexible enough to allow a user to define a level-based hierarchy where each level can take values from a different data domain, and relationships between any two levels (or at a single level) can be different in nature.

Shown in FIG. 7 is diagram 700, illustrating a model logical entity framework for this example embodiment. The model framework includes: managed hierarchy entity 710; hierarchy level entity 715; level end point entity 720; relationship entity 725; and relationships 730a and 730b. Managed hierarchy entity 710 corresponds to a level-based hierarchy, and contains one or more hierarchy levels 715. Each level has two level end points 720 containing a reference to the data domains at that level (levelSet) and at the parent level (parentSet). In addition, it also contains references to relationship objects 725 defining various kinds of relationships. Level end point entity 720 is flexible enough to reference any valid end point (set of values). It also contains a type attribute specifying the type of end point being incorporated at that particular level.

Relationship entity 725 contains references to various kinds of relationships 730a that could be used to define a level in the level hierarchy. It is sub-classed by Mapping, Property (attribute relationship), or a simple Hierarchy on a set of values. Generic rule-based relationship entity 730b provides enough extensibility to insert any custom rule, given a level, governing relationships to the next level.

This framework can then be used to define a level-based hierarchy over a multitude of data and existing relationships using the algorithm discussed in the following paragraphs.

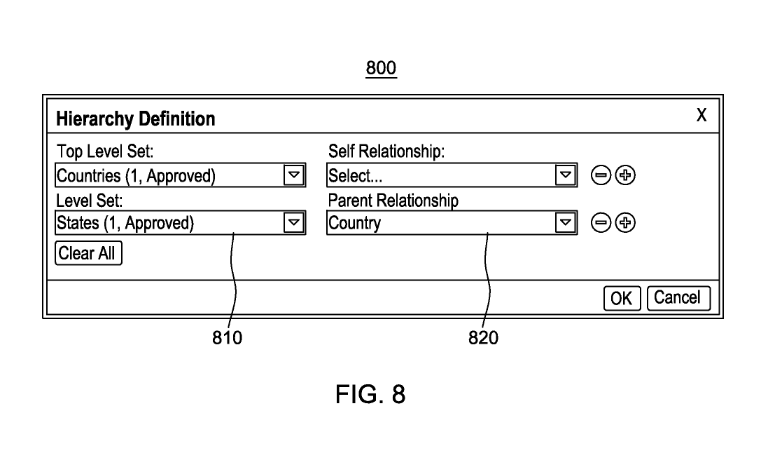

Step (i): A user launches a user interface associated with the framework. For example, simple definition widget 800, shown in FIG. 8, is used in this embodiment to define a level hierarchy powered by the underlying model. Widget 800 includes drop-down list boxes 810 and 820.

Step (ii): At each level, a user specifies the relationship (for example, attribute relation, mapping, or simple hierarchy) via drop-down list box 820, and the data domain (for example, reference data set or master data management domain), which that level comprises, via drop-down list box 810. User interface widget 800 is not aware of the data sources or relationships since the intermediate layer decouples that knowledge and encapsulates it in the relationship model (see FIG. 7).

Step (iii): As the user specifies levels, a Level Suggestion Module (LSM), further discussed below, runs in the background to determine if a reasonable suggestion for the next level can be made. For instance, if reasonCount>threshold, the drop-down list box for the next level is auto-completed with the suggestion. The user retains the final decision on whether to accept or reject the suggestion. Depending on whether the user accepts or rejects the suggestion, LSM is adjusted accordingly.

Step (iv): Once done with all the definitions, the user presses “OK” and initiates the process of creating the level definition. This creates underlying objects based on the above model (see FIG. 7) and stores references to the data objects and relationships. Many of these references, such as levelEndPoint and rule-based relationships, are identifiers pointing to an external system.

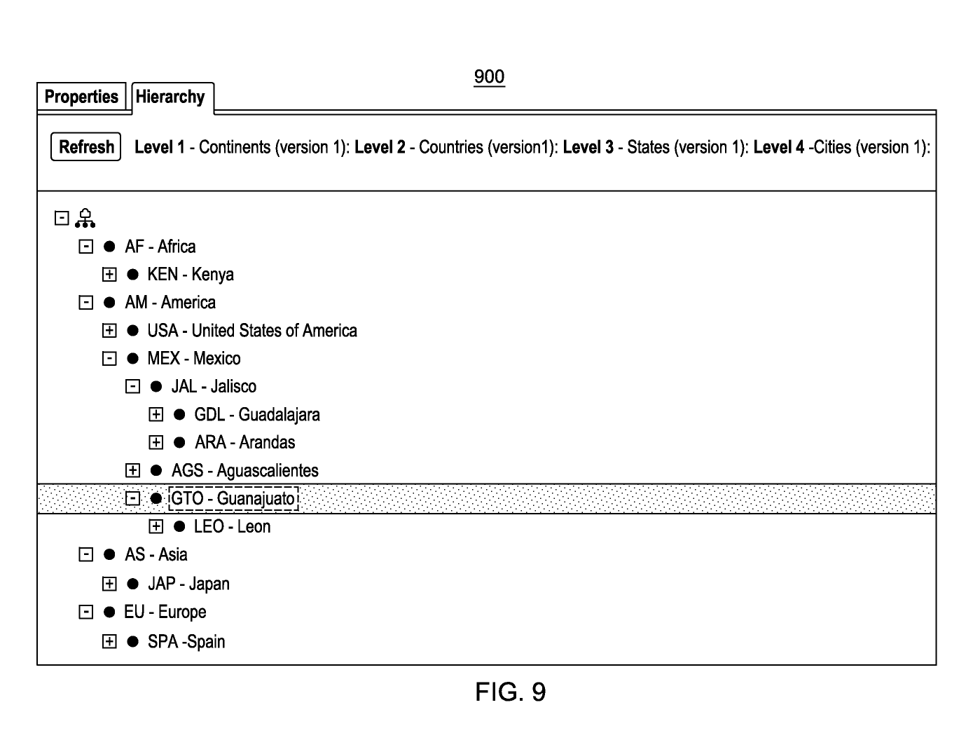

Step (v): Finally, the user triggers the visualization view, shown in screenshot 900 of FIG. 9, which displays the level structure along with some of the provenance information (data set name and version for each level) that provides an indication of the source of the data at a particular level.

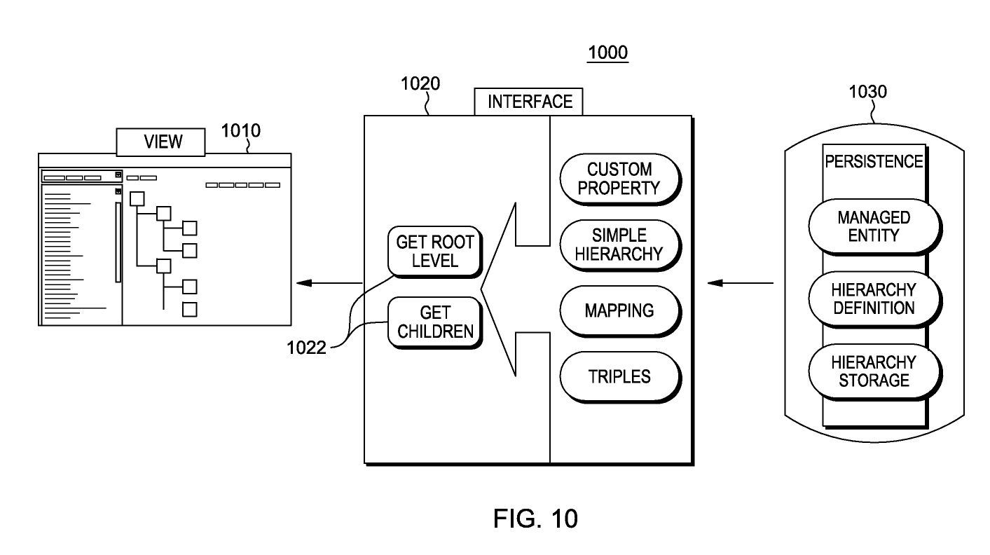

Diagram 1000 of FIG. 10 shows high-level decoupling between level-based hierarchy visualization 1010 and persistence 1030 thru intermediate interface 1020, which includes application programming interface (API) functions 1022. This interface hides different kinds of relationships and end points from the representation on the user interface. This flexible design also allows for an alternate flow where a user could programmatically invoke the service interface to construct, persist and visualize the level hierarchy without going thru the user interface. The interface provides a single point of entry for all the data and relationships required to create the hierarchy, and a simple API to read it. The read API can be entirely transparent to the underlying variance in data and relationships. For instance, it can be as simple as using API functions 1022 to get the root nodes and invoke the getChildren interface on each node, which performs a breath-first expansion. Since the model only retains references to data and relationships, if the data or relationships in remote systems change, the references automatically pick them up. The level definition acts as a central point that brings everything together, decoupling the hierarchy from where the actual data resides.

As discussed above, the Level Suggestion Module (LSM) of this example embodiment attempts to make a reasonable suggestion for the next level when a user is defining a level hierarchy. An exemplary embodiment for the LSM algorithm follows.

Step (i): Get all the levels specified by the user before this call and store them in set {L_i}, where L_i: {S_i, R_i}. S_i denotes the levelSet at that level (see FIG. 7), and R_i denotes the relationship connecting that level to the previous level.

Step (ii): Perform the following searches to determine an adequate suggestion for the current level:

Step (ii) (a): First, refer to any enterprise dictionaries or glossaries to find terms matching {S_k} for all k prior to this call. If found, refer to term descriptions or categorizations and compare them with {R_j} for all j prior to this call to find any matching information about implicit or explicit relationships between any pair of {S_k}. Next, search any neighboring terms or terms categorized under the same class in the dictionary or glossary structure and rank them based on associativity to the terms corresponding to {S_k}. For example, Countries, States and Cities may be three terms, all grouped under the category ‘Geo.’ Assign reasonCount for each candidate term depending on the degree of associativity.

Step (ii) (b): Next, refer to enterprise ontologies to find concepts matching {S_k} for all k prior to this call. If found, search to find matching patterns corresponding to {S_k, R_j, S_t} triples. For example, there could be concepts in the ontology corresponding to “Country”—hasState “State”—hasCity—“City”. By matching {Country, State} and {hasState} triple, the search should be able to discover {City} and {hasCity} as a candidate concept and relationship for the next level. If a direct path is not found, try to find indirect paths (where concepts in {S_k} are separated by 2 or more edges) and assign reasonCount accordingly. The more the separation, the less reasonable the suggestion. For example, an ontology may have “Country” and “State” concepts but they may not be linked directly. Instead, Country—hasCitizen—Person, State—hasEmployee—Employee. Employee—isA—Person. Although indirect, this relationship does indicate a weak associativity between “Country” and “State”: namely, both are closely related to the “Person” concept. This evidence could be used to increment the reason Count and if it is greater than a certain pre-defined threshold, “State” could be suggested as the next level when a user selects “Country” as level 1 while defining a multi-level hierarchy.

Some embodiments of the present disclosure provide one or more of the following features, characteristics, and/or advantages: (i) a framework that is flexible in modeling and visualizing level-based hierarchies over different kinds of data and relationships using reference data to categorize data in an enterprise system and reference data over multiple systems across different domains; (ii) a framework to intelligently define level-based hierarchies over data and relations from multiple systems and domains; (iii) flexibility to allow users to dynamically add custom data or relationships to existing data; (iv) a user interface (UI) that provides an easy way to create and update different kinds of relationships in the model; (v) a UI that allows users to dynamically generate a multi-level hierarchy data structure and to persist the hierarchy for management; (vi) a framework to capture complex data relationships on demand without modifying a base data model, as well as data within each domain; (vii) a framework that will allow the user to easily model and visualize level-based hierarchies over different kinds of data and with different kinds of relationships (one-one, one-many, many-many, and so forth); (viii) a framework that has the capability to render a hierarchy representation between entities that are “related in different forms,” like, maps, properties, custom rules, and so on, without changing the ‘actual base data/model;’ (ix) the ability to formalize and visualize level hierarchies using existing relationships from multi-domain data; and/or (x) the ability to model and visualize relations over multiple domains and systems.

### IV. DEFINITIONS

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

User/subscriber: includes, but is not necessarily limited to, the following: (i) a single individual human; (ii) an artificial intelligence entity with sufficient intelligence to act as a user or subscriber; and/or (iii) a group of related users or subscribers.

Data communication: any sort of data communication scheme now known or to be developed in the future, including wireless communication, wired communication and communication routes that have wireless and wired portions; data communication is not necessarily limited to: (i) direct data communication; (ii) indirect data communication; and/or (iii) data communication where the format, packetization status, medium, encryption status and/or protocol remains constant over the entire course of the data communication.

Receive/provide/send/input/output: unless otherwise explicitly specified, these words should not be taken to imply: (i) any particular degree of directness with respect to the relationship between their objects and subjects; and/or (ii) absence of intermediate components, actions and/or things interposed between their objects and subjects.

Module/Sub-Module: any set of hardware, firmware and/or software that operatively works to do some kind of function, without regard to whether the module is: (i) in a single local proximity; (ii) distributed over a wide area; (ii) in a single proximity within a larger piece of software code; (iii) located within a single piece of software code; (iv) located in a single storage device, memory or medium; (v) mechanically connected; (vi) electrically connected; and/or (vii) connected in data communication.

Software storage device: any device (or set of devices) capable of storing computer code in a manner less transient than a signal in transit.

Tangible medium software storage device: any software storage device (see Definition, above) that stores the computer code in and/or on a tangible medium.

Non-transitory software storage device: any software storage device (see Definition, above) that stores the computer code in a non-transitory manner.

Computer: any device with significant data processing and/or machine readable instruction reading capabilities including, but not limited to: desktop computers, mainframe computers, laptop computers, field-programmable gate array (fpga) based devices, smart phones, personal digital assistants (PDAs), body-mounted or inserted computers, embedded device style computers, application-specific integrated circuit (ASIC) based devices.

Level-based hierarchy: any hierarchical relationship between two data sets wherein the relationship is one of the following relationship types: (i) map, (ii) property (or attribute), (iii) rule-based, or (iv) hybrid (any combination of the foregoing types).

Parent-child hierarchy: any hierarchical relationship between two data sets that is not a “level-based hierarchy.”

Relationship definition: an example of a relationship definition of a relationship according to a map relationship type relationship is “each city in a second data set will be a child node of a parent node of a state from a first data set in accordance with how cities are correlated with states in a predetermined city/state table”; an example of a relationship definition of a relationship according to a property relationship type relationship is “each city in a second data set will be a child node of a parent node in accordance with an ‘inState’ property associated respectively with each city in the second data set”; an example of a relationship definition of a relationship according to a rule-based relationship type relationship is “each city in a second data set will be a child node of a parent node of a state in which the city's current mayor was born.”

Domain: a scoped, well-defined collection of concepts, assumptions and constraints. For instance, in terms of enterprise information management systems, Party is a domain and can represent a Person or an Organization. Similarly, Product is a domain. Contract, Location and Customer are some other examples. There are many ways to model and implement a domain. For instance, Party and Product can be modeled and/or implemented in a master data management (MDM) system. For an enterprise information management system such as an MDM system, different domains (like Party, Product, Customer, Contract, and Location) represent structures off of which various master data entities can be based. Data from different domains can be inter-related through relationships, which can, in turn, be visualized in a level hierarchy structure.

System: a system is a physical embodiment that holds domain entities. For instance, a SAP system can hold master data domain entities like Person, Organization, and so on. (Note: the term(s) “SAP” may be subject to trademark rights in various jurisdictions throughout the world and are used here only in reference to the products or services properly denominated by the marks to the extent that such trademark rights may exist.)

1-8. (canceled)

9. A computer program product comprising software stored on a software storage device, the software comprising:
first program instructions programmed to identify a first set of machine readable data including a first level set from a first domain;
second program instructions programmed to identify a second set of machine readable data including a second level set from a second domain;
third program instructions programmed to receive a first relationship type to be used between the first level set and the second level set; and
fourth program instructions programmed to formalize a first hierarchy, including at least the first level set and the second level set joined in a hierarchical relationship according to the first relationship type;
wherein:
the software is stored on a software storage device in a manner less transitory than a signal in transit.

10. The product of claim 9 wherein the fourth program instructions are further programmed to receive user input identifying the first relationship type.

11. The product of claim 9 further comprising:
the fourth program instructions further programmed to further formalize the first hierarchy by designating a first relationship definition specifying substance of a relationship according to the first relationship type.

12. The product of claim 11 wherein the software further comprises:
fifth program instructions programmed to render a visual image of the first hierarchy wherein the first relationship definition is implicit in the visual image.

13. The product of claim 9 wherein:
the first level set comes from a first data storage system; and
the second level set comes from a second data storage system with the second data storage system being different from the first data storage system.

14. The product of claim 11 wherein the software further comprises:
fifth program instructions programmed to identify a third set of machine readable data including a third level set;
sixth program instructions programmed to receive a second relationship type to be used between the second level set and the third level set;
seventh program instructions programmed to designate a second relationship definition specifying substance of a relationship according to the second relationship type; and
eighth program instructions programmed to further formalize the first hierarchy, including the third level set, according to the second relationship type and the second relationship definition;
wherein:
the first relationship definition has a type and/or cardinality that is different from the second relationship definition.

15. A computer system comprising:
a processor(s) set; and
a software storage device;
wherein:
the processor set is structured, located, connected and/or programmed to run software stored on the software storage device; and
the software comprises:
first program instructions programmed to identify a first set of machine readable data including a first level set from a first domain;
second program instructions programmed to identify a second set of machine readable data including a second level set from a second domain;
third program instructions programmed to receive a first relationship type to be used between the first level set and the second level set; and
fourth program instructions programmed to formalize a first hierarchy, including at least the first level set and the second level set joined in a hierarchical relationship according to the first relationship type.

16. The system of claim 15 wherein the fourth program instructions are further programmed to receive user input identifying the first relationship type.

17. The system of claim 15 wherein the software further comprises:
the fourth program instructions further programmed to further formalize the first hierarchy by designating a first relationship definition specifying substance of a relationship according to the first relationship type.

18. The system of claim 17 wherein the software further comprises:
fifth program instructions programmed to render a visual image of the first hierarchy wherein the first relationship definition is implicit in the visual image.

19. The system of claim 15 wherein:
the first level set comes from a first data storage system; and
the second level set comes from a second data storage system with the second data storage system being different from the first data storage system.

20. The system of claim 17 wherein the software further comprises:
fifth program instructions programmed to identify a third set of machine readable data including a third level set;
sixth program instructions programmed to receive a second relationship type to be used between the second level set and the third level set;
seventh program instructions programmed to designate a second relationship definition specifying substance of a relationship according to the second relationship type; and
eighth program instructions programmed to further formalize the first hierarchy, including the third level set, according to the second relationship type and the second relationship definition;
wherein:
the first relationship definition has a type and/or cardinality that is different from the second relationship definition.
